(19) United States
(12) Patent Application Publication
(10) Pub. No.: US 2016/0301079 A1
(43) Pub. Date: Oct. 13, 2016

(54) POSITIVE ELECTRODE FOR NONAQUEOUS ELECTROLYTE SECONDARY BATTERY

(71) Applicant: SANYO ELECTRIC CO., LTD., Daito-shi, Osaka (JP)

(72) Inventors: Takao Kokubu, Osaka (JP); Takeshi Ogasawara, Hyogo (JP); Fumiharu Niina, Hyogo (JP)

(73) Assignee: SANYO ELECTRIC CO., LTD., Daito-shi, Osaka (JP)

(21) Appl. No.: 15/037,223

(22) PCT Filed: Nov. 20, 2014
(86) PCT No.: PCT/JP2014/005846

§ 371 Date: May 17, 2016

(30) Foreign Application Priority Data
Nov. 29, 2013 (JP) 2013-247140

(51) Int. Cl. H01M 4/62; H01M 4/66; H01M 4/525; H01M 4/131; H01M 4/505

(52) U.S. Cl. CPC H01M 4/628; H01M 4/131; H01M 4/505; H01M 4/525; H01M 4/625; H01M 4/623; H01M 4/661; H01M 2004/028

(57) ABSTRACT

Provided is a positive electrode for nonaqueous electrolyte secondary batteries. The positive electrode allows the batteries to operate with a limited loss of initial efficiency even if the positive electrode has been exposed to air. In an aspect of a positive electrode for nonaqueous electrolyte secondary batteries according to the present invention, the positive electrode for nonaqueous electrolyte secondary batteries contains positive electrode active material particles and a boron compound. The positive electrode active material particles are composed of a lithium transition metal oxide and a rare earth compound adhering to the surface thereof.

### TECHNICAL FIELD

The present invention relates to a positive electrode for nonaqueous electrolyte secondary batteries.

### BACKGROUND ART

The rapid development of mobile information terminals such as cellphones, laptops, and smartphones into smaller and lighter ones in recent years has led to a need for higher-capacity secondary batteries as power supplies for driving them. Nonaqueous electrolyte secondary batteries, which charge and discharge through the movement of lithium ions between positive and negative electrodes in association with charging and discharging, are widely used as power supplies to drive such mobile information terminals because of their high energy density and high capacity.

More recently, nonaqueous electrolyte secondary batteries have been focused on as power supplies for the operation of electric tools, electric vehicles (EVs), and hybrid electric vehicles (HEVs and PHEVs) and are expected to be used in a broader range of fields. Such a power supply for machine operation needs to have an increased, capacity that, allows for extended use and improved output characteristics for repeated high-rate charge and discharge in a relatively short period. In particular, in applications such as electric tools, EVs, HEVs, and PHEVs, it is essential to achieve a high capacity while maintaining output characteristics during high-rate charge and discharge.

For example, PTL 1 below suggests that allowing an element of Group 3 in the periodic table to be present on the surfaces of matrix positive electrode active material particles reduces the damage to charge and storage characteristics from the decomposition of a liquid electrolyte that occurs at the interface between the positive electrode active material and the liquid electrolyte in association with increased charging voltage.

Furthermore, PTL 2 below demonstrates that heating a positive electrode active material that contains lithium and at least one of nickel and cobalt with a boric acid compound attached thereto increases the capacity and improves the charge and discharge efficiency.

### CITATION LIST

### Patent Literature

PTL 1: International Publication No. WO2005/008812

PTL 2: Japanese Published Unexamined Patent Application No. 2009-146739

### SUMMARY OF INVENTION

### Technical Problem

It was, however, found that even with the technologies disclosed in PTL 1 and 2 above, it is impossible to reduce the loss of initial efficiency when the positive electrode active material or the positive electrode has been exposed to air.

According to an aspect of the present invention, an object is to provide a positive electrode for nonaqueous electrolyte secondary batteries and a positive electrode active material for nonaqueous electrolyte secondary batteries that allow the batteries to operate with a limited loss of initial efficiency even if the positive electrode active material or the positive electrode has been exposed to air.

### Solution to Problem

According to an aspect of the present invention, a positive electrode for nonaqueous electrolyte secondary batteries contains positive electrode active material particles and a boron compound. The positive electrode active material particles are composed of a lithium transition metal oxide and a rare earth compound adhering to the surface thereof.

According to an aspect of the present invention, a positive electrode active material for nonaqueous electrolyte secondary batteries contains a lithium transition metal oxide, a rare earth compound adhering to the surface of the lithium transition metal oxide, and a boron compound adhering to the surface of the lithium transition metal oxide.

### Advantageous Effects of Invention

According to an aspect of the present invention, a positive electrode for nonaqueous electrolyte secondary batteries and a positive electrode active material for nonaqueous electrolyte secondary batteries are provided that allow the batteries to operate with a limited loss of initial efficiency even if the positive electrode active material or the positive electrode has been exposed to air.

### BRIEF DESCRIPTION OF DRAWINGS

FIG. 1 is a schematic front view of a nonaqueous electrolyte secondary battery according to an aspect of the present invention.

FIG. 2 is a schematic cross-section taken along line A-A in FIG. 1.

### DESCRIPTION OF EMBODIMENTS

The following describes an embodiment of the present invention. This embodiment is an example of a way of implementing the present invention, and the present invention is not limited to this embodiment.

### <Nonaqueous Electrolyte Secondary Battery>

A nonaqueous electrolyte secondary battery as an example of an embodiment of the present invention has a positive electrode, a negative electrode, and a nonaqueous electrolyte. An example of a nonaqueous electrolyte secondary battery is, for example, a structure in which an electrode body, which is a roll or stack of a positive electrode and a negative electrode having a separator therebetween, and a nonaqueous liquid electrolyte, which is a nonaqueous electrolyte in the form of liquid, are contained in a battery sheathing can, but is not limited to this.

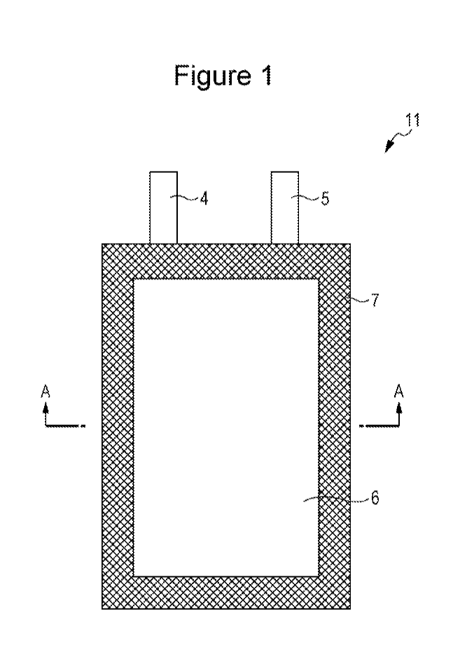

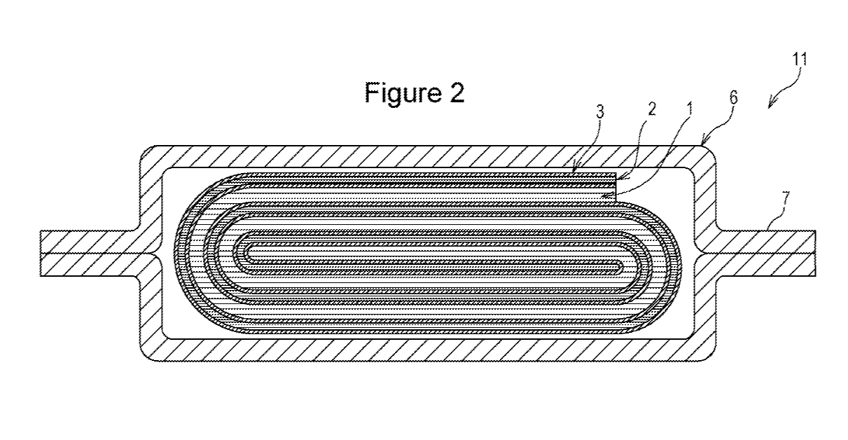

As illustrated in FIG. 1 and FIG. 2, the detailed structure of this nonaqueous electrolyte secondary battery 11 includes a roll of a positive electrode 1 and a negative electrode 2 facing each other with a separator 3 therebetween, and the flat electrode body composed of these positive and negative electrodes 1, 2 and the separator 3 has been impregnated with a nonaqueous liquid electrolyte. The positive electrode 1 and the negative electrode 2 are connected to a positive electrode collector tab 4 and a negative electrode collector tab 5, respectively, and this structure allows the battery to charge and discharge as a secondary battery. The electrode body is located in a storage space in a laminated aluminum sheathing body 6 that has heat-seal sections 7 heat-sealed at their peripheries. The following describes the individual components of a nonaqueous electrolyte secondary battery as an example of this embodiment.

### [Positive Electrode]

A positive electrode for nonaqueous electrolyte secondary batteries as an example of an embodiment of the present invention contains positive electrode active material particles and a boron compound. The positive electrode active material particles are composed of a lithium transition metal oxide and a rare earth compound adhering to the surface thereof. The positive electrode is preferably composed of a positive electrode collector and a positive electrode mixture layer formed on the positive electrode collector. The positive electrode collector is, for example, a conductive thin-film body, in particular, a foil of a metal or alloy that is stable in the range of positive electrode potentials, such as aluminum, or a film that has a surface layer of a metal such as aluminum. The positive electrode mixture layer preferably contains a binder and a conductive agent in addition to the positive electrode active material particles.

The presence of the rare earth compound adhering to the surface of the lithium transition metal oxide inhibits the reaction through which LiOH forms (more specifically, the reaction in which water existing on the surface of the lithium transition metal oxide and the lithium transition metal oxide react with each other, the reaction occurs through which Li and hydrogen in the surface layer of the lithium transition metal oxide are exchanged, and the Li is extracted from the lithium transition metal oxide to form LiOH), which is a cause of the damage to characteristics from atmospheric exposure, thereby reducing the damage to initial charge and discharge characteristics associated with atmospheric exposure, or the loss of charge and discharge efficiency that occurs when the battery charges and discharges after exposure to air.

Furthermore, the presence of the boron compound contained in the positive electrode reduces the surface energy of the lithium transition metal oxide and limits the adsorption of atmospheric water onto the lithium transition metal oxide. This effect is an interaction that is obtained when the boron compound coexists with a rare earth compound, and should be lost if the boron compound does not coexist with a rare earth compound. The limited adsorption of water onto the lithium transition metal oxide also leads to reduced availability of water for the aforementioned LiOH-forming reaction. The LiOH-forming reaction as a cause of the damage to characteristics from atmospheric exposure is therefore further inhibited, and this leads to further reduced damage to initial charge and discharge characteristics following atmospheric exposure. This sort of synergy prevents the LiOH-forming reaction as a cause of the damage to characteristics from atmospheric exposure and, as a result, dramatically reduces the damage to initial charge and discharge characteristics associated with atmospheric exposure.

The lithium transition metal composite oxide contains nickel and manganese. The molar proportion of nickel is larger than the molar proportion of manganese, and the difference in molar proportion between nickel and manganese is 0.25 or more. Such a lithium transition metal composite oxide can be a nickel-manganese compound or a nickel-cobalt-manganese compound. For lithium nickel cobalt manganese oxide in particular, it is preferred to use one in which the molar ratios of nickel to cobalt to manganese are 5:3:2, 6:2:2, 7:1:2, 7:2:1, or 8:1:1. Especially for the reason that the aforementioned LiOH-forming reaction is more likely to occur, not only for the purpose of potential increase in the capacity of the positive electrode, an oxide is used that is richer in nickel than in manganese and in which the difference in molar proportion between nickel and manganese is 0.25 or more when the total molar quantity of transition metals is 1. These can be used alone or in mixture.

The difference in molar proportion between nickel and manganese is preferably 0.60 or less. When the difference in molar proportion between nickel and manganese exceeds 0.60, the LiOH-forming reaction is very likely to occur.

In the positive electrode for nonaqueous electrolyte secondary batteries as an example of this embodiment, the positive electrode active material particles are preferably composed of a lithium transition metal oxide and a boron compound adhering to the surface thereof. This enhances the aforementioned synergy between the rare earth compound and the boron compound, further improving the loss of initial charge and discharge characteristics due to atmospheric exposure.

It is preferred to use at least one rare earth compound selected from hydroxides, oxyhydroxides, oxides, carbonic acid compounds, phosphoric acid compounds, and fluorides of rare earth metals. It is particularly preferred to use at least one selected from hydroxides and oxyhydroxides of rare earth metals. The use of these rare earth compounds leads to more effective reduction of the loss of initial efficiency caused by atmospheric exposure. Hydroxides and oxyhydroxides of rare earth metals further increase the energy requirement for the activation of the reaction through which LiOH forms.

Examples of rare earth metals contained in the rare earth compound include scandium, yttrium, lanthanum, cerium, praseodymium, neodymium, samarium, europium, gadolinium, terbium, dysprosium, holmium, erbium, thulium, ytterbium, and lutetium. Among these, neodymium, samarium, and erbium are particularly preferred. Compounds of neodymium, samarium, and erbium, having small average particle diameters compared with other rare earth compounds, are relatively likely to separate out uniformly dispersed over the entire surfaces of the particles of the lithium transition metal oxide.

Besides hydroxides and oxyhydroxides such as neodymium hydroxide, neodymium oxyhydroxide, samarium hydroxide, samarium oxyhydroxide, erbium hydroxide, and erbium oxyhydroxide, specific examples of rare earth compounds include phosphoric acid compounds and carbonic acid compounds such as neodymium phosphate, samarium phosphate, erbium phosphate, neodymium carbonate, samarium carbonate, and erbium carbonate as well as oxides and fluorides such as neodymium oxide, samarium oxide, erbium oxide, neodymium fluoride, samarium fluoride, and erbium fluoride. Among these, the hydroxides and oxyhydroxides are particularly preferred because of the more uniform dispersion they achieve on the entire surfaces of the particles when attached to the particles than the others, the greater ease of distributing them selectively on the surfaces of particles, and so forth.

The average particle diameter of the rare earth compound is preferably 1 nm or more and 100 nm or less, more preferably 10 nm or more and 50 nm or less. When the average particle diameter of the rare earth compound is more than 100 nm, the particle diameter of the rare earth compound is too large/and the particles of the rare earth compound adhering to the surfaces of the particles of the lithium transition metal oxide are few in number. This may lead to poor effectiveness in improving the output at low temperatures. When the average particle diameter of the rare earth compound is less than 1 nm, the surfaces of the particles of the lithium transition metal oxide are densely covered with the rare earth compound. This may affect the capability of the surfaces of the particles of the lithium transition metal oxide to store or release lithium ions and lead to poor charge and discharge characteristics.

The proportion of the rare earth compound (the amount of the adhering compound) to the total mass of the lithium transition metal oxide is preferably 0.005% by mass or more and 0.5% by mass or less, more preferably 0.05% by mass or more and 0.3% by mass or less, on a rare earth metal basis. When this proportion is less than 0.005% by mass, the aforementioned effect of the rare earth compound and the boron compound may be insufficient for the loss of initial charge and discharge characteristics due to exposure of electrode plates to be reduced. When this proportion is more than 0.5% by mass, the surfaces of the particles of the lithium transition metal oxide may be covered so excessively that the initial charge and discharge characteristics may be poor regardless of whether electrode plates are exposed or not.

The lithium transition metal oxide may contain other elements added thereto. Examples of elements to be added include boron (B), magnesium (Mg), aluminum (Al), titanium (Ti), chromium (Cr), iron (Fe), copper (Cu), zinc (Zn), niobium (Mb), molybdenum (Mo), tantalum (Ta), zirconium (Zr), tin (Sn), tungsten (W), sodium (Na), potassium (K), barium (Ba), strontium (Sr), and calcium (Ca).

The lithium transition metal oxide can be particles having an average particle diameter of 2 to 30 μm, and these particles may be in the form of secondary particles formed through the association of primary particles of 100 nm to 10 μm.

A method used to manufacture a positive electrode for nonaqueous electrolyte secondary batteries as an example of this embodiment includes adding an aqueous solution of a compound that contains a rare earth metal to a suspension that contains a lithium transition metal oxide.

When this method is used, it is desirable to prepare the pH of the suspension to within the range of 6 or more and 10 or less and hold it constant while adding the aqueous solution of a compound that contains a rare earth metal to the suspension. This is because at pH levels less than 6, the lithium transition metal oxide may dissolve. At pH levels more than 10, however, particles of the rare earth compound adhere unevenly to, or only to part of, the surfaces of the lithium transition metal oxide particles when the aqueous solution of a compound that contains a rare earth metal is added to the suspension. That is, fine particles of the rare earth compound do not adhere to the surfaces of the lithium transition metal oxide particles uniformly dispersed over the entire surfaces of the particles. This not only leads to uneven lowering effect on surface energy, but also may cause the inhibitory effect on the aforementioned LiOH-forming reaction not to be sufficiently inhibitory over the entire surfaces of the particles of the lithium transition metal oxide.

An example of an alternative method is to spray or add dropwise an aqueous or other solution of a compound that contains a rare earth metal to a lithium transition metal composite oxide while stirring the lithium transition metal composite oxide. Another is to add a compound that contains a rare earth metal to a lithium transition metal composite oxide and mechanically mix them. The method for mechanical mixing can be, for example, Ishikawa's grinding mixer or a twin-shaft planetary mixer (e.g., HIVIS MIX, PRIMIX Corporation). Equipment such as Hosokawa Micron's Kobilta and Mechanofusion can also be used.

However, more uniform dispersion of fine particles of the rare earth compound over the entire surfaces of the particles of the lithium transition metal composite oxide would ensure that the progress of the LiOH-forming reaction that occurs when water is adsorbed onto the surface of the lithium transition metal composite oxide is more effectively inhibited. Thus, particularly preferred is the method in which an aqueous solution of a compound that contains a rare earth metal is added to a suspension that contains a lithium transition metal composite oxide.

When adding the aqueous solution of a compound that contains a rare earth metal to the suspension that contains a lithium transition metal oxide, the manufacturer can make the product separate out as a hydroxide by simply doing this in water, and as a fluoride by adding a sufficient amount of a fluorine source to the suspension beforehand. Dissolving sufficient carbon dioxide gives a carbonic acid compound, adding sufficient phosphate ions to the suspension gives a phosphoric acid compound, and the rare earth compound can be separated out on the surfaces of the particles of the lithium transition metal oxide. By controlling the ions dissolved in the suspension, furthermore, it is possible to obtain, for example, a mixture of a hydroxide and a fluoride of a rare earth metal.

The particles of the lithium transition metal oxide with the rare earth compound separated out on their surfaces can then be heated. The heating temperature is preferably roughly from 80° C. to 500° C., more preferably roughly from 80° C. to 400° C. At less than 80° C., it may take excessively long to dry the particles sufficiently. At more than 500° C., part of the surface-adhering rare earth compound may diffuse into the particles of the lithium transition metal composite oxide and the lowering effect on surface energy may be affected. When the heating temperature is 400° C. or less, little of the rare earth metal diffuses into the particles of the lithium transition metal composite oxide with the rest present selectively on the surfaces of the particles, resulting in particularly great lowering effect on surface energy. When the surface-adhering rare earth compound is a hydroxide, it turns into an oxyhydroxide at approximately 200° C. to approximately 300° C. and into an oxide at approximately 450° C. to approximately 500° C. This means that heating at 400° C. or less selectively leaves a rare earth hydroxide or oxyhydroxide, which is highly effective in inhibiting the LiOH-forming reaction, on the surfaces of the particles and ensures uniform dispersion of the compound over the entire surfaces of the particles, thereby providing great resistance to atmospheric exposure.

The compound that contains a rare earth metal and is dissolved in the aqueous solution can be a solution of a rare earth compound such as a rare earth acetate, a rare earth nitrate, a rare earth sulfate, a rare earth oxide, or a rare earth chloride in water or an organic solvent. Those rare earth sulfates, rare earth chlorides, and rare earth nitrates that are obtained by dissolving rare earth oxides in sulfuric acid, hydrochloric acid, and nitric acid are equivalent to the above aqueous solutions and can therefore be used.

The boron compound is preferably boric acid, lithium borate, lithium metaborate, or lithium tetraborate. Among these, lithium metaborate is particularly preferred. The use of these boron compounds leads to more effective reduction of the loss of initial charge and discharge efficiency caused by atmospheric exposure.

The proportion of the boron compound to the total mass of the lithium transition metal oxide is preferably 0.005% by mass or more and 5% by mass or less, more preferably 0.01% by mass or more and 0.2% by mass or less, on an elemental boron basis. When this proportion is less than 0.005% by mass, the effect of the rare earth compound and the boron compound may be insufficient for the damage to characteristics from atmospheric exposure of electrode plates to be reduced. When this proportion is more than 5% by mass, the amount of the positive electrode active material is accordingly small, and therefore the capacity of the positive electrode is low.

Apart from mechanically mixing a lithium transition metal oxide and a boron compound beforehand for adhesion, a positive electrode that contains a boron compound can be produced by adding a boron compound together with a conductive agent and a binder during the step of kneading the conductive agent and the binder. The method for mechanical mixing can be, for example, Ishikawa's grinding mixer or a twin-shaft planetary mixer (e.g., HIVIS MIX, PRIMIX Corporation). Equipment such as Hosokawa Micron's Nobilta and Mechanofusion can also be used.

The particle diameter of the boron compound particles is preferably smaller than the particle diameter of the lithium transition metal oxide, in particular, smaller than 1/10 of that of the lithium transition metal oxide. When the boron compound is larger than the lithium transition metal composite oxide, its area of contact with the lithium transition metal oxide may be so small that its effect is insufficient.

The boron compound only needs to be present in the vicinity of the rare earth compound. Even in this situation, the aforementioned effect of the boron compound and the rare earth compound is obtained. In other words, the boron compound may be adhering to the surfaces of the particles of the lithium transition metal oxide and may alternatively be present in the vicinity of the rare earth compound, rather than adhering to the surfaces, in the positive electrode. It is particularly preferred to attach the boron compound selectively to the surfaces of the particles of the lithium transition metal oxide beforehand by mixing it with the lithium transition metal oxide or any other method. This enhances the synergy between the boron compound and the rare earth compound.

The positive electrode active material is not limited to the form in which positive electrode active material particles composed of a lithium transition metal oxide and a rare earth compound adhering to the surface thereof or positive electrode active material particles composed of a lithium transition metal oxide and a rare earth compound and a boron compound adhering to the surface thereof are used alone. It is also possible to use these positive electrode active material particles mixed with another positive electrode active material. This positive electrode active material can be any compound to and from which lithium ions can be reversibly inserted and removed. For example, compounds such as those having a layered structure, a spinel structure, or an olivine structure to and from which lithium ions can be inserted and removed while maintaining a stable crystal structure can be used. When only a single positive electrode active material is used or different positive electrode active materials are used, the positive electrode active material or materials may have a constant particle diameter or different particle diameters.

The binder can be a material such as a fluorinated polymer or a rubber-like polymer. Examples of fluorinated polymers include polytetrafluoroethylene (PTFE), polyvinylidene fluoride (PVdF), and their altered forms, and examples of rubber-like polymers include ethylene-propylene-isoprene copolymers and ethylene-propylene-butadiene copolymers. These can be used alone, and it is also possible to use two or more of them in combination. The binder may be used in combination with a thickener such as carboxymethyl cellulose (CMC) or polyethylene oxide (PEG).

The conductive agent can be, for example, a carbon material, and examples include carbon materials such as carbon black, acetylene black, ketjen black, and graphite. These can be used alone, and it is also possible to use two or more of them in combination.

The positive electrode active material for nonaqueous electrolyte secondary batteries as an example of an embodiment of the present invention contains a lithium transition metal oxide, a rare earth compound adhering to the surface of the lithium transition metal oxide, and a boron compound adhering to the surface of the lithium transition metal oxide. This results in the aforementioned synergy between the rare earth compound and the boron compound, and the damage to initial charge and discharge characteristics associated with atmospheric exposure is reduced.

### [Negative Electrode]

The negative electrode can be a conventional negative electrode and is obtained by, for example, mixing a negative electrode active material and a binder in water or any appropriate solvent, applying the mixture to a negative electrode collector, drying the applied coating, and rolling the collector. The negative electrode collector is preferably, for example, a conductive thin-film body, in particular, a foil of a metal or alloy that is stable in the range of negative electrode potentials, such as copper, or a film that has a surface layer of a metal such as copper. The binder can be a material such as PTFE as in the positive electrode, but it is preferred to use a material such as a styrene-butadiene copolymer (SBR) or its altered form. The binder may be used in combination with a thickener such as CMC.

The negative electrode active material can be any material capable of reversibly storing and releasing lithium ions and can be, for example, a carbon material, a metal or alloy material that forms an alloy with lithium, such as Si or Sri, or a metal oxide. These can be used alone or as a mixture of two or more. Combinations of negative electrode active materials selected from carbon materials, metals or alloy materials that form alloys with lithium, and metal oxides can also be used.

### [Nonaqueous Electrolyte]

The solvent for the nonaqueous electrolyte can be a conventional one, i.e., a cyclic carbonate such as ethylene carbonate, propylene carbonate, butylene carbonate, or vinylene carbonate or a linear carbonate such as dimethyl carbonate, methyl ethyl carbonate, or diethyl carbonate. It is particularly preferred to use a solvent mixture composed of a cyclic carbonate and a linear carbonate as a nonaqueous solvent highly conductive to lithium ions because of its high dielectric constant, low viscosity, and low melting point. The ratio by volume of the cyclic carbonate to the linear carbonate in this solvent mixture is preferably limited to the range of 2:8 to 5:5.

These solvents can be used in combination with, for example, ester-containing compounds such as methyl acetate, ethyl acetate, propyl acetate, methyl propionate, ethyl propionate, and γ-butyrolactone; compounds containing a sulfone group such as propanesultone; ether-containing compounds such as 1,2-dimethoxyethane, 1,2-diethoxyethane, tetrahydrofuran, 1,3-dioxane, 1,4-dioxane, and 2-methyltetrahydrofuran; nitrile-containing compounds such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide-containing compounds such as dimethylformamide. Solvents obtained through partial substitution of their hydrogen atoms H with fluorine atoms F can also be used.

The solute for the nonaqueous electrolyte can be a conventional solute and can be, for example, LiPF₆, LiBF₄, LiCF₃SG₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, or LiAsF₆, which are fluorine-containing lithium salts. If is also possible to use a solute obtained by adding a lithium salt other than fluorine-containing lithium salts [a lithium salt that contains one or more of elements P, B, O, S, N, and Cl (e.g., LiClO₄)] to a fluorine-containing lithium salt. It is particularly preferred to use solutes including a fluorine-containing lithium salt and a lithium salt that contains an oxalato complex as anion because this ensures a stable coating is formed on the surface of the negative electrode even under high-temperature conditions.

Examples of such lithium salts that contain an oxalato complex as anion include LiBOB [lithium-bisoxalatoborate], Li[B(C₂O₄)F₂], Li[P(C₂O₄)F₄], and Li[P(C₂O₄)₂F₂]. Among these, LiBOB is particularly preferred as it allows a stable coating to be formed on the negative electrode.

These solutes can be used alone, and it is also possible to use two or more of them in mixture.

The separator can be a conventional separator. For example, polypropylene or polyethylene separators, polypropylene-polyethylene multilayer separators, and separators with their surfaces coated with resin such as an aramid resin can be used.

There can be a conventional inorganic filler layer at the interface between the positive electrode and the separator or the interface between the negative electrode and the separator. The filler can also be a conventional one, i.e., an oxide or phosphoric acid compound that contains one or more of elements such as titanium, aluminum, silicon, and magnesium or such a compound with its surface treated with a hydroxide or similar. The filler layer can be formed by applying filler-containing slurry directly to the positive electrode, negative electrode, or separator to form the layer, by attaching a sheet of the filler to the positive electrode, negative electrode, or separator, or by any other method.

### EXAMPLES

The following describes an embodiment of the present invention in more detail by providing some experimental examples. These experimental examples are given to illustrate examples of a positive electrode for nonaqueous electrolyte secondary batteries, a nonaqueous electrolyte secondary battery, and a positive electrode active material for nonaqueous electrolyte secondary batteries that are provided to embody the technical ideas behind the present invention, and the present invention is in no way limited to these experimental examples. The present invention can be implemented with any necessary change unless its gist is altered.

### First Experiment

### Experimental Example 1

The configuration of the nonaqueous electrolyte secondary battery of Experimental Example 1 is described first.

### [Production of Positive Electrode Active Material]

[Ni_{0.55}Mn_{0.20}Co_{0.25}](OH)₂ obtained by coprecipitation and Li₂CO₃ were mixed in Ishikawa's grinding mortar to a molar ratio of Li to all transition metals of 1.05:1. The mixture was then fired at 950° C. for 10 hours in an air atmosphere and milled to give a lithium-nickel-manganese-cobalt composite oxide represented by Li_{1.06}[Ni_{0.55}Mn_{0.20}Co_{0.25}]O₂ having an average secondary particle diameter of approximately 14 μm.

The resulting lithium-nickel-manganese-cobalt composite oxide particles as a lithium transition metal oxide were scaled to be 1000 g. These particles were added to 3.0 L of purified water, and the mixture was stirred to give a suspension in which the lithium transition metal oxide was dispersed. To this suspension, an aqueous solution of 5.42 g of erbium nitrate pentahydrate [Er(NO₃)₃.5H₂O] in 200 mL of purified water was added. While the aqueous solution of erbium nitrate pentahydrate was being added to the suspension, a 10% by mass aqueous solution of nitric acid or a 10% by mass aqueous solution of sodium hydroxide was added as needed to adjust the pH of the solution in which the lithium transition metal oxide was dispersed to 9 and hold it constant.

After the completion of the addition of the solution of erbium nitrate pentahydrate, the suspension was suction-filtered. The residue was washed in water, and the resulting powder was dried at 120° C. to give a substance composed of the lithium transition metal oxide and erbium hydroxide adhering to part of the surface thereof. The resulting powder was then heated at 300° C. for 5 hours in an air atmosphere. In this way, positive electrode active material particles were produced. This heat treatment at 300° C., through which all or a substantial part of the surface-adhering erbium hydroxide turns into erbium oxyhydroxide, leaves erbium oxyhydroxide adhering to the surfaces of the lithium transition metal oxide particles. Since some part may remain in the form of erbium hydroxide, there may be erbium hydroxide attached to the surfaces of the lithium transition metal oxide particles.

The resulting positive electrode active material particles were observed under a scanning electron microscope (SEM), and it was found that an erbium compound having an average particle diameter of not more than 100 nm was adhering to the surfaces of the lithium transition metal oxide particles uniformly dispersed over the entire surfaces of the particles. The amount of the adhering erbium compound as measured by ICP was 0.20% by mass of the lithium transition metal oxide particles (a lithium-nickel-manganese-cobalt composite oxide) on an elemental erbium basis.

### [Production of Positive Electrode Plate]

The positive electrode active material particles, lithium metaborate, carbon black as a conductive agent, and a solution of polyvinylidene fluoride as a binder in N-methyl-2-pyrrolidone were scaled to ratios by mass of the positive electrode active material particles to lithium metaborate to the conductive agent to the binder of 94.5:2.5:2.5, and the scaled materials were kneaded to give positive electrode mixture slurry. Before kneading, the positive electrode active material particles and lithium metaborate were mixed using T.K. HIVIS MIX (PRIMIX Corporation) in advance. After the lithium metaborate came into contact with the positive electrode active material particles and the particles were thoroughly dispersed, the particles were kneaded with the conductive agent and the binder using T.K. HIVIS MIX (PRIMIX Corporation).

This positive electrode mixture slurry was then applied to both sides of a positive electrode collector that was an aluminum foil. After the applied coatings were dried, the collector was rolled using a roller, and an aluminum collector tab was attached. In this way, a positive electrode plate was produced that was composed of a positive electrode collector and a positive electrode mixture layer formed on both sides thereof.

The resulting positive electrode plate was observed under a scanning electron microscope (SEM), and it was found that particles of lithium metaborate having an average particle diameter of not more than 500 nm were adhering to the surface of the lithium transition metal oxide or the surface of the erbium compound. Part of the lithium metaborate may detach from the surfaces of the positive electrode active material particles during the step of mixing the conductive agent and the binder, and thus some lithium metaborate may be contained in the positive electrode not adhering to the positive electrode active material particles. It was also found that the lithium metaborate was adhering to the erbium compound or present in the vicinity of the erbium compound.

### [Production of Negative Electrode]

Artificial graphite as a negative electrode active material, CMC (sodium carboxymethyl cellulose) as a dispersant, and SBR (styrene-butadiene rubber) as a binder were mixed in ratios by mass of 98:1:1 in an aqueous solution to give negative electrode mixture slurry. This negative electrode mixture slurry was uniformly applied to both sides of a negative electrode collector that was a copper foil. The applied coatings were dried, the collector was rolled using a roller, and a nickel collector tab was attached. In this way, a negative electrode plate was produced that was composed of a negative electrode collector and a negative electrode mixture layer formed on both sides thereof. The packing density of the negative electrode active material in this negative electrode was 1.70 g/cm³.

### [Preparation of Nonaqueous Liquid Electrolyte]

Ethylene carbonate (EC), methyl ethyl carbonate (MEC), and dimethyl carbonate (DEC) were mixed in ratios by volume of 3:6:1, and in the resulting solvent mixture, lithium hexafluorophosphate (LiPF₆) was dissolved to a concentration of 1.0 mole/liter. Furthermore, by adding 2.0% by mass vinylene carbonate (VC) into the resulting solvent mixture, a nonaqueous liquid electrolyte was prepared.

### [Production of Battery]

The positive electrode and negative electrode obtained in this way were wound into a spiral with a separator positioned between the two electrodes, and the winding core was removed to produce a spiral electrode body. This spiral electrode body was then pressed to obtain a flat electrode body. This flat electrode body and the aforementioned nonaqueous liquid electrolyte were inserted into a laminated aluminum sheathing body, producing a nonaqueous electrolyte secondary battery. The size of the nonaqueous electrolyte secondary battery was 3.6 mm thick×35 mm wide×62 mm long. The discharge capacity of the nonaqueous electrolyte secondary battery when charged to 4.40 V and discharged to 2.75 V was 800 mAh. The battery produced in this way is hereinafter referred to as battery A1.

[Production of Battery with Positive Electrode Plate Exposed to Air]

A battery with its positive electrode plate exposed to air (battery B1) was produced in the same way as battery A1 above except that the production of the positive electrode plate included exposing the collector to air under the following conditions after rolling it using a roller.

### —Atmospheric Exposure Conditions

Left in a thermo-hygrostat chamber at a temperature of 30° C. and a humidity of 50% for 5 days

### Experimental Example 2

A battery was produced in the same way as battery A1 above except that the positive electrode active material particles were a lithium-nickel-manganese-cobalt composite oxide represented by Li_{1.06}[Ni_{0.55}Mn_{0.20}Co_{0.25}]O₂ with no erbium compound attached thereto and that in the production of the positive electrode plate the mixing of lithium metaborate was omitted. The battery produced in this way is hereinafter referred to as battery A2.

A battery with its positive electrode plate exposed to air (battery B2) was produced in the same way as battery A2 above except that the production of the positive electrode plate included exposing the collector to air under the above conditions after rolling it using a roller.

### Experimental Example 3

A battery was produced in the same way as battery A1 above except that the positive electrode active material particles were a lithium-nickel-manganese-cobalt composite oxide represented by Li_{0.06}[Ni_{0.55}Mn_{0.20}Co_{0.25}]O₂ with no erbium compound attached thereto. The battery produced in this way is hereinafter referred to as battery A3.

A battery with its positive electrode plate exposed to air (battery B3) was produced in the same way as battery A3 above except that the production of the positive electrode plate included exposing the collector to air under the above conditions after rolling it using a roller.

### Experimental Example 4

A battery was produced in the same way as battery A1 above except that in the production of the positive electrode plate the mixing of lithium metaborate was omitted. The battery produced in this way is hereinafter referred to as battery A4.

A battery with its positive electrode plate exposed to air (battery B4) was produced in the same way as battery A4 above except that the production of the positive electrode plate included exposing the collector to air under the above conditions after rolling it using a roller.

### Experimental Example 5

A battery was produced in the same way as battery A1 above except that the positive electrode active material particles were a lithium-nickel-manganese-cobalt composite oxide represented by Li_{1.06}[Ni_{0.50}Mn_{0.30}Co_{0.20}]O₂. The battery produced in this way is hereinafter referred to as battery A5.

A battery with its positive electrode plate exposed to air (battery B5) was produced in the same way as battery A5 above except that the production of the positive electrode plate included exposing the collector to air under the above conditions after rolling it using a roller.

### Experimental Example 6

A battery was produced in the same way as battery A1 above except that the positive electrode active material particles were a lithium-nickel-manganese-cobalt composite oxide represented by Li_{1.06}[Ni_{0.50}Mn_{0.30}Co_{0.20}]O₂ with no erbium compound attached thereto and that in the production of the positive electrode plate the mixing of lithium metaborate was omitted. The battery produced in this way is hereinafter referred to as battery A6.

A battery with its positive electrode plate exposed to air (battery B6) was produced in the same way as battery A6 above except that the production of the positive electrode plate included exposing the collector to air under the above conditions after rolling it using a roller.

### Experimental Example 7

A battery was produced in the same way as battery A1 above except that the positive electrode active material particles were a lithium-nickel-manganese-cobalt composite oxide represented by Li_{1.06}[Ni_{0.50}Mn_{0.30}Co_{0.20}]O₂ with no erbium compound attached thereto. The battery produced in this way is hereinafter referred to as battery A7.

A battery with its positive electrode plate exposed to air (battery B7) was produced in the same way as battery A7 above except that the production of the positive electrode plate included exposing the collector to air under the above conditions alter rolling it using a roller.

### Experimental Example 8

A battery was produced in the same way as battery A5 above except that in the production of the positive electrode plate the mixing of lithium metaborate was omitted. The battery produced in this way is hereinafter referred to as battery A8.

A battery with its positive electrode plate exposed to air (battery B8) was produced in the same way as battery A8 above except that the production of the positive electrode plate included exposing the collector to air under the above conditions after rolling it using a roller.

### Experimental Example 9

A battery was produced in the same way as battery A1 above except that the positive electrode active material particles were a lithium-nickel-manganese-cobalt composite oxide represented by Li_{1.06}[Ni_{0.51}Mn_{0.26}Co_{0.23}]O₂. The battery produced in this way is hereinafter referred to as battery A9.

A battery with its positive electrode plate exposed to air (battery B3) was produced in the same way as battery A3 above except that the production of the positive electrode plate included exposing the collector to air under the above conditions after rolling it using a roller.

### Experimental Example 10

A battery was produced in the same way as battery A1 above except that the positive electrode active material particles were a lithium-nickel-manganese-cobalt composite oxide represented by Li_{1.06}[Ni_{0.51}Mn_{0.26}Co_{0.23}]O₂ with no erbium compound attached thereto and that in the production of the positive electrode plate the mixing of lithium metaborate was omitted. The battery produced in this way is hereinafter referred to as battery A10.

A battery with its positive electrode plate exposed to air (battery B10) was produced in the same way as battery A10 above except that the production of the positive electrode plate included exposing the collector to air under the above conditions after rolling it using a roller.

### Experimental Example 11

A battery was produced in the same way as battery A1 above except that the positive electrode active material particles were a lithium-nickel-manganese-cobalt composite oxide represented by Li_{1.06}[Ni_{0.51}Mn_{0.26}Co_{0.23}]O₂ with no erbium compound attached thereto. The battery produced in this way is hereinafter referred to as battery A11.

A battery with its positive electrode plate exposed to air (battery B11) was produced in the same way as battery A11 above except that the production of the positive electrode plate included exposing the collector to air under the above conditions after rolling it using a roller.

### Experimental Example 12

A battery was produced in the same way as battery A9 above except that in the production of the positive electrode plate the mixing of lithium metaborate was omitted. The battery produced in this way is hereinafter referred to as battery A12.

A battery with its positive electrode plate exposed to air (battery B12) was produced in the same way as battery A12 above except that the production of the positive electrode plate included exposing the collector to air under the above conditions after rolling it using a roller.

### Experimental Example 13

A battery was produced in the same way as battery A1 above except that the positive electrode active material particles were a lithium-nickel-manganese-cobalt composite oxide represented by Li_{1.06}[Ni_{0.70}Mn_{0.10}Co_{0.20}]O₂. The battery produced in this way is hereinafter referred to as battery A13.

A battery with its positive electrode plate exposed to air (battery B13) was produced in the same way as battery A13 above except that the production of the positive electrode plate included exposing the collector to air under the above conditions after rolling it using a roller.

### Experimental Example 14

A battery was produced in the same way as battery A1 above except that the positive electrode active material particles were a lithium-nickel-manganese-cobalt composite oxide represented by Li_{1.06}[Ni_{0.70}Mn_{0.10}Co_{0.20}]O₂ with no erbium compound attached thereto and that in the production of the positive electrode plate the mixing of lithium metaborate was omitted. The battery produced in this way is hereinafter referred to as battery A14.

A battery with its positive electrode plate exposed to air (battery B14) was produced in the same way as battery A14 above except that the production of the positive electrode plate included exposing the collector to air under the above conditions after rolling it using a roller.

### Experimental Example 15

A battery was produced in the same way as battery A1 above except that the positive electrode active material particles were a lithium-nickel-manganese-cobalt composite oxide represented by Li_{1.06}[Ni_{0.70}Mn_{0.10}Co_{0.20}]O₂ with no erbium compound attached thereto. The battery produced in this way is hereinafter referred to as battery A15.

A battery with its positive electrode plate exposed to air (battery 615) was produced in the same way as battery A15 above except that the production of the positive electrode plate included exposing the collector to air under the above conditions after rolling it using a roller.

### Experimental Example 16

A battery was produced in the same way as battery A13 above except that in the production of the positive electrode plate the mixing of lithium metaborate was omitted. The battery produced in this way is hereinafter referred to as battery A16.

A battery with its positive electrode plate exposed to air (battery B16) was produced in the same way as battery A16 above except that the production of the positive electrode plate included exposing the collector to air under the above conditions after rolling it using a roller.

### <Measurement of Initial Charge and Discharge Efficiency>

The following charge and discharge test was performed on batteries A1 to A16, which were produced with their positive electrode plates not exposed to air under the above conditions, and battery B1 to battery B16, which were produced in the same way as batteries A1 to A16 but with their positive electrode plates exposed to air under the above conditions, to measure the initial charge and discharge efficiency of each battery.

### —Charging Conditions in Cycle 1

Under 25° C. temperature conditions, constant-current charging was performed at a constant current of 800 mA until the battery voltage reached 4.4 V (a positive electrode potential of 4.5 V with lithium as the reference), and after the battery voltage reached 4.4 V, constant-voltage charging was performed at a constant voltage of 4.4 V until the current reached 40 mA.

### —Discharging Conditions in Cycle 1

Under 25° C. temperature conditions, constant-current discharge was performed at a constant current of 800 mA until a battery voltage of 3.0 V was reached.

### —Halt

The duration of the halt between the above charging and discharge was 10 minutes.

With charging and discharge under the above conditions constituting one cycle, the initial charge and discharge efficiency in Cycle 1 was determined from, the measured charge capacity and the measured discharge capacity on the basis of formula (1) below.

Initial charge and discharge efficiency (%)=Discharge capacity/Charge capacity×100 (1)

### <Calculation of Exposure Damage Index>

Of the initial charge and discharge efficiencies determined above, the initial charge and discharge efficiency without atmospheric exposure (with the positive electrode plate not exposed to air) was defined as “unexposed initial efficiency,” and the initial charge and discharge efficiency with atmospheric exposure (with the positive electrode plate exposed to air) was defined as “exposed initial efficiency.” The exposure damage index was calculated from the difference between the unexposed initial efficiency and exposed initial efficiency of the corresponding batteries on the basis of formula (2) below.

Exposure damage index=(Unexposed initial efficiency)−(Exposed initial efficiency) (2)

A summary of the results is given in Table 1 below.

TABLE 1

| | Molar proportions | | | | | Atmospheric exposure |
|---|---|---|---|---|---|---|
| | of nickel | | | Rare earth metal in | | damage index |
| | and manganese | | | the rare earth | Boron | (Unexposed initial efficiency- |
| | Ni | Mn | Ni − Mn | compound | compound | Exposed initial efficiency) (%) |
| Experimental | 0.55 | 0.20 | 0.35 | Er | LiBO₂ | 0.04 |
| Example 1 | | | | | | |
| Experimental | 0.55 | 0.20 | 0.35 | None | None | 1.88 |
| Example 2 | | | | | | |
| Experimental | 0.55 | 0.20 | 0.35 | None | LiBO₂ | 1.90 |
| Example 3 | | | | | | |
| Experimental | 0.55 | 0.20 | 0.35 | Er | None | 1.56 |
| Example 4 | | | | | | |
| Experimental | 0.50 | 0.30 | 0.20 | Er | LiBO₂ | 0.29 |
| Example 5 | | | | | | |
| Experimental | 0.50 | 0.30 | 0.20 | None | None | 0.36 |
| Example 6 | | | | | | |
| Experimental | 0.50 | 0.30 | 0.20 | None | LiBO₂ | 0.55 |
| Example 7 | | | | | | |
| Experimental | 0.50 | 0.30 | 0.20 | Er | None | 1.44 |
| Example 8 | | | | | | |
| Experimental | 0.51 | 0.26 | 0.25 | Er | LiBO₂ | 0.07 |
| Example 9 | | | | | | |
| Experimental | 0.51 | 0.26 | 0.25 | None | None | 0.89 |
| Example 10 | | | | | | |
| Experimental | 0.51 | 0.26 | 0.25 | None | LiBO₂ | 1.76 |
| Example 11 | | | | | | |
| Experimental | 0.51 | 0.26 | 0.25 | Er | None | 1.38 |
| Example 12 | | | | | | |
| Experimental | 0.70 | 0.10 | 0.60 | Er | LiBO₂ | 0.08 |
| Example 13 | | | | | | |
| Experimental | 0.70 | 0.10 | 0.60 | None | None | 2.11 |
| Example 14 | | | | | | |
| Experimental | 0.70 | 0.10 | 0.60 | None | LiBO₂ | 2.88 |
| Example 15 | | | | | | |
| Experimental | 0.70 | 0.10 | 0.60 | Er | None | 3.08 |
| Example 16 | | | | | | |

As can be seen from the results in Table 1 above, the batteries of Experimental Examples 1, 9, and 13, in which erbium oxyhydroxide and lithium metaborate were adhering to the surfaces of particles of a lithium transition metal oxide and the difference in molar proportion between nickel and manganese was 0.25 or more, exhibited greatly reduced exposure damage indices as compared with the batteries of Experimental Examples 2 to 4, 5 to 8, 10 to 12, and 14 to 16. The batteries of Experimental Examples 3, 7, 11, and 15, in which only lithium metaborate was attached, and the batteries of Experimental Examples 4, 8, 12, and 16, in which only erbium oxyhydroxide was attached, were comparable to the batteries of Experimental Examples 2, 6, 10, and 14, which contained neither of them, in terms of atmospheric exposure damage index. However, the batteries of Experimental Examples 1, 9, and 13, which combined the configurations of Experimental Examples 3, 7, 11, and 15 and Experimental Examples of 4, 8, 12, and 16, demonstrated an improvement much greater than the individual effects. The reason for these results should be as follows.

In the case of the battery of Experimental Example 1, in which erbium oxyhydroxide and lithium metaborate were together adhering to the surface of a lithium transition metal oxide, the erbium oxyhydroxide inhibits the progress of the reaction through which LiOH forms (more specifically, the reaction in which water existing on the surface of the lithium transition metal oxide and the lithium transition metal oxide react with each other, the reaction occurs through which Li and hydrogen in the surface layer of the lithium transition metal oxide are exchanged, and the Li is extracted from the lithium transition metal oxide to form LiOH), which is a cause of the damage to characteristics from atmospheric exposure. This seemingly reduces the damage to initial charge and discharge characteristics associated with atmospheric exposure, or the loss of charge and discharge efficiency that occurs when the battery charges and discharges after exposure to air.

Furthermore, the surface energy of the lithium transition metal oxide is reduced by an interaction between lithium metaborate and erbium oxyhydroxide, and this limits the adsorption of atmospheric water onto the lithium transition metal compound. This decrease in the amount of adsorbed water seemingly leads to further inhibition of the progress of the aforementioned LiOH-forming reaction, a cause of the damage to characteristics from atmospheric exposure, further reducing the damage to initial charge and discharge characteristics following atmospheric exposure. This sort of synergy prevents the LiOH-forming reaction as a cause of the damage to characteristics from atmospheric exposure and, as a result, dramatically reduces the damage to initial charge and discharge characteristics associated with atmospheric exposure, or the loss of charge and discharge efficiency that occurs when the battery charges and discharges after exposure to air.

The aforementioned interaction between a boron compound and erbium oxyhydroxide is an action of the boron compound that occurs when the boron compound coexists with a rare earth compound. It should therefore be lost when the boron compound exists alone.

In the case of the batteries of Experimental Examples 4, 8, 12, and 16, in which only erbium oxyhydroxide was adhering, such a synergy between erbium oxyhydroxide and lithium metaborate is not obtained. That is, the presence of erbium oxyhydroxide slightly inhibits the aforementioned LiOH-forming reaction as a cause of the damage due to atmospheric exposure, but due to the absence of a boron compound, the surface energy of the lithium transition metal oxide cannot be reduced, leading to a large amount of water adsorbed onto the surface of the lithium transition metal oxide. It appears that this led to accelerated progress of the aforementioned LiOH-forming reaction as a cause of the damage to atmospheric exposure, and the damage to initial charge and discharge characteristics following atmospheric exposure was not sufficiently reduced.

In the case of the batteries of Experimental Examples 3, 7, 11, and 15, too, in which only lithium metaborate was adhering, such a synergy between erbium oxyhydroxide and lithium metaborate is not obtained. That is, as stated above, it appears that the decrease in surface energy by lithium metaborate should not occur when the lithium metaborate exists alone, not coexisting with a rare earth compound. It appears that this resulted in the failure to reduce the adsorption of atmospheric water onto the lithium transition metal oxide and led to accelerated progress of the aforementioned LiOH-forming reaction. The batteries of Experimental Examples 3, 7, 11, and 15, furthermore, contained no rare earth compound and therefore lacked the inhibitory effect of a rare earth compound on the aforementioned LiOH-forming reaction. As a result, Experimental Examples 2, 6, 10, and 14 and Experimental Examples 3, 7, 11, and 15 gave comparable results, indicating that simply attaching a boron compound as in Experimental Examples 3, 7, 11, and 15 is not effective in reducing the damage to initial charge and discharge characteristics associated with atmospheric exposure.

In the case of the batteries of Experimental Examples 2, 6, 10, and 14, there Is no erbium oxyhydroxide or lithium metaborate adhering to the surface of the lithium transition metal oxide. Thus neither the effect of erbium oxyhydroxide nor the synergy between erbium oxyhydroxide and lithium metaborate is obtained. As a result, seemingly, the aforementioned reaction through which LiOH forms was not inhibited, and the damage to initial charge and discharge characteristics associated with atmospheric exposure was not reduced.

The batteries of Experimental Example 5 had both erbium oxyhydroxide and lithium metaborate adhering to the surface of the lithium transition metal oxide. However, the difference in molar proportion between nickel and manganese was 0.20, and thus the reduction of the damage to initial charge and discharge characteristics associated with atmospheric exposure was insufficient as compared with that in Experimental Examples 1, 9, and 13, in which the difference in molar proportion between nickel and manganese was 0.25 or more. This should be because when the difference in molar proportion between nickel and manganese was 0.20 or less, the damage to initial charge and discharge characteristics due to atmospheric exposure was small even with no surface element, present as in Experimental Example 6, and therefore the improving effect of erbium oxyhydroxide and lithium metaborate was not noticeable.

### Second Experiment 3

### Experimental Example 17

A battery was produced in the same way as battery A1 above except that in the production of the positive electrode active material particles, the rare earth compound was samarium nitrate hexahydrate instead of erbium nitrate pentahydrate. The battery produced in this way is hereinafter referred to as battery A17.

As a result of all or a substantial part of surface-adhering samarium hydroxide turning into samarium oxyhydroxide through heat treatment, the resulting positive electrode active material was composed of positive electrode active material particles and samarium oxyhydroxide adhering to the surfaces thereof. Since some part may remain in the form of samarium hydroxide, there may be samarium hydroxide attached to the surfaces of the lithium transition metal oxide particles. These positive electrode active material particles were observed under a scanning electron microscope (SEM), and it was found that a samarium compound having an average particle diameter of not more than 100 nm was adhering to the surfaces of the lithium transition metal oxide particles uniformly dispersed over the entire surfaces of the particles. The amount of the adhering samarium compound as measured by TCP was 0.20% by mass of the lithium-nickel-manganese-cobalt composite oxide on an elemental samarium basis.

Corresponding to battery A17, a battery with its positive electrode plate exposed to air (battery B17) was produced in the same way as battery A17 above except that the production of the positive electrode plate included exposing the collector to air under the above conditions after rolling it using a roller.

### Experimental Example 18

A battery was produced in the same way as battery A17 above except that in the production of the positive electrode plate the mixing of lithium metaborate was omitted. The battery produced in this way is hereinafter referred to as battery A18.

Corresponding to battery A18, a battery with its positive electrode plate exposed to air (battery B18) was produced in the same way as battery A18 above except that the production of the positive electrode plate included exposing the collector to air under the above conditions after rolling it using a roller.

### Experimental Example 19

A battery was produced in the same way as battery A1 above except that in the production of positive electrode active material particles, the rare earth compound was neodymium nitrate hexahydrate instead of erbium nitrate pentahydrate. The battery produced in this way is hereinafter referred to as battery A19.

As a result of all or a substantial part of surface-adhering neodymium hydroxide turning into neodymium oxyhydroxide through heat treatment, the resulting positive electrode active material particles were composed of lithium transition metal oxide particles and neodymium oxyhydroxide adhering to the surfaces thereof. Since some part may remain in the form of neodymium hydroxide, there may be neodymium hydroxide attached to the surfaces of the lithium transition metal oxide particles. This positive electrode active material was observed under a scanning electron microscope (SEM), and it was found that a neodymium compound having an average particle diameter of not more than 100 nm was adhering to the surfaces of the lithium transition metal oxide particles uniformly dispersed over the entire surfaces of the particles. The amount of the adhering neodymium compound as measured by ICP was 0.20% by mass of the lithium-nickel-manganese-cobalt composite oxide on an elemental neodymium basis.

Corresponding to battery A19, a battery with its positive electrode plate exposed to air (battery B19) was produced in the same way as battery A19 above except that the production of the positive electrode plate included exposing the collector to air under the above conditions after rolling it using a roller.

### Experimental Example 20

A battery was produced in the same way as battery A19 above except that in the production of the positive electrode plate the mixing of lithium metaborate was omitted. The battery produced in this way is hereinafter referred to as battery A20.

Corresponding to battery A20, a battery with its positive electrode plate exposed to air (battery B20) was produced in the same way as battery A20 above except that the production of the positive electrode plate included exposing the collector to air under the above conditions after rolling it using a roller.

For the batteries of battery A17 to battery A20, which were produced with their positive electrode plates not exposed to air under the above conditions, and battery B17 to battery B20, which were produced in the same way as battery A17 to battery A20 but with their positive electrode plates exposed to air under the above conditions, the exposure damage index was calculated in the same way as in First Experiment above. A summary of the results is given in Table 2 below, along with the results obtained with the batteries of Experimental Examples 1 and 4.

TABLE 2

| | | | Atmospheric exposure |
|---|---|---|---|
| | Rare earth | | damage index |
| | metal in the | | (Unexposed initial |
| | rare earth | Boron | efficiency − Exposed |
| | compound | compound | initial efficiency) (%) |
| Experimental | Er | LiBO₂ | 0.04 |
| Example 1 | | | |
| Experimental | Er | None | 1.56 |
| Example 4 | | | |
| Experimental | Sm | LiBO₂ | 0.14 |
| Example 17 | | | |
| Experimental | Sm | None | 1.63 |
| Example 18 | | | |
| Experimental | Nd | LiBO₂ | 0.09 |
| Example 19 | | | |
| Experimental | Nd | None | 1.71 |
| Example 20 | | | |

As can be seen from the results in Table 2 above, the batteries of Experimental Examples 17 and 19, in which the lithium transition metal oxide had a samarium compound or a neodymium compound attached to part of its surface instead of an erbium compound, exhibited greatly reduced exposure damage indices as compared with the batteries of Experimental Examples 18 and 20, which correspond to the batteries of Experimental Examples 17 and 19 and contained no boron compound.

This result indicates that even with a samarium compound or a neodymium compound, the effects obtained are equivalent to those with an erbium compound. This suggests that attaching a rare earth compound to the surface of the lithium transition metal oxide inhibits the aforementioned LiOH-forming reaction as a cause of the damage to characteristics from atmospheric exposure, thereby reducing the damage to initial charge and discharge characteristics associated with atmospheric exposure. This operational advantage seems to be an effect common to rare earth compounds.

Comparing results among the batteries of Experimental Examples 1, 17, and 19 reveals that the batteries of Experimental Example 1 exhibited a lower exposure damage index than the batteries of Experimental Examples 17 and 19. This indicates that among rare earth metals, erbium compounds are particularly preferred.

### Third Experiment

### Experimental Example 21

A battery was produced in the same way as battery A1 above except that in the production of the positive electrode plate, the boron compound was lithium tetraborate instead of lithium metaborate. The battery produced in this way is hereinafter referred to as battery A21.

Corresponding to battery A21, a battery with its positive electrode plate exposed to air (battery B21) was produced in the same way as battery A21 above except that the production of the positive electrode plate included exposing the collector to air under the above conditions after rolling it using a roller.

### Experimental Example 22

A battery was produced in the same way as battery A21 above except that the positive electrode active material particles were a lithium-nickel-manganese-cobalt composite oxide represented by Li_{1.06}[Ni_{0.55}Mn_{0.20}Co_{0.25}]O₂ with no erbium compound attached thereto. The battery produced in this way is hereinafter referred to as battery A22.

Corresponding to battery A22, a battery with its positive electrode plate exposed to air (battery B22) was produced in the same way as battery A22 above except that the production of the positive electrode plate included exposing the collector to air under the above conditions after rolling it using a roller.

For the batteries of battery A21 to battery A22, which were produced with their positive electrode plates not exposed to air under the above conditions, and battery B21 to battery B22, which were produced in the same way as battery A21 to battery A22 but with their positive electrode plates exposed to air under the above conditions, the exposure damage index was calculated in the same way as in First Experiment above. A summary of the results is given in Table 3 below along with the results obtained with the batteries of Experimental Examples 1 and 3.

TABLE 3

| | | | Atmospheric exposure |
|---|---|---|---|
| | Rare earth | | damage index |
| | metal in the | | (Unexposed initial |
| | rare earth | Boron | efficiency − Exposed |
| | compound | compound | initial efficiency) (%) |
| Experimental | Er | LiBO₂ | 0.04 |
| Example 1 | | | |
| Experimental | None | LiBO₂ | 1.90 |
| Example 3 | | | |
| Experimental | Er | Li₂B₄O₇ | 0.23 |
| Example 21 | | | |
| Experimental | None | Li₂B₄O₇ | 1.83 |
| Example 22 | | | |

As can be seen from the results in Table 3 above, the batteries of Experimental Example 21, in which the lithium transition metal oxide had lithium tetraborate attached to part of its surface instead of lithium metaborate, exhibited a greatly reduced exposure damage index as compared with the batteries of Experimental Example 22, which correspond to the batteries of Experimental Example 21 and contained no erbium compound.

The above result indicates that even with lithium tetraborate, the effects obtained are equivalent to those with lithium metaborate, and this result seems to be an common effect that is obtained when a boron-containing compound is used. Comparing results between the batteries of Experimental Examples 1 and 21 reveals that the batteries of Experimental Example 1 exhibited a lower exposure damage index than the batteries of Experimental Example 21. This indicates that among boron compounds, lithium metaborate is particularly preferred.

### INDUSTRIAL APPLICABILITY

The positive electrode according to an aspect of the present invention for nonaqueous electrolyte secondary batteries and nonaqueous electrolyte secondary batteries incorporating it can be applied to power supplies for mobile information terminals such as cellphones, laptops, smartphones, and tablet terminals, particularly in applications in which a high energy density is required. They are also expected to expand into high-power applications such as electric vehicles (EVs), hybrid electric vehicles (HEVs and PHEVs), and electric tools.

### REFERENCE SIGNS LIST

1 Positive electrode
2 Negative electrode
3 Separator
4 Positive electrode collector tab
5 Negative electrode collector tab
6 Laminated aluminum sheathing body
7 Heat-seal section
11 Nonaqueous electrolyte secondary battery

1. A positive electrode for a nonaqueous electrolyte secondary battery, the positive electrode comprising:
positive electrode active material particles; and
at least one boron compound, wherein
the positive electrode active material particles contain a lithium transition metal oxide,
at least one rare earth compound is adhering to a surface of the lithium transition metal oxide, and
the lithium transition metal oxide contains nickel and manganese, a molar proportion of the nickel is larger than a molar proportion of the manganese, and a difference in molar proportion between the nickel and the manganese is 0.25 or more.

2. The positive electrode according to claim 1 for a nonaqueous electrolyte secondary battery, wherein the difference in molar proportion between the nickel and the manganese is 0.60 or less.

3. The positive electrode according to claim 1 for a nonaqueous electrolyte secondary battery, wherein the lithium transition metal oxide contains nickel in a molar proportion of 0.5 or more.

4. The positive electrode according to claim 1 for a nonaqueous electrolyte secondary battery, wherein the at least one boron compound is adhering to the surface of the lithium transition metal oxide.

5. The positive electrode according to claim 1 for a nonaqueous electrolyte secondary battery, wherein the at least boron compound is selected from boric acid, lithium borate, lithium metaborate, and lithium tetraborate.

6. The positive electrode according to claim 1 for a nonaqueous electrolyte secondary battery, wherein a particle diameter of the at least one boron compound is smaller than 1/10 of a particle diameter of the lithium transition metal oxide.

7. The positive electrode according to claim 1 for a nonaqueous electrolyte secondary battery, wherein the at least one rare earth compound is selected from hydroxides, oxyhydroxides, oxides, carbonic acid compounds, phosphoric acid compounds, and fluorides.

8. The positive electrode according to claim 7 for a nonaqueous electrolyte secondary battery, wherein the at least one rare earth compound is selected from hydroxides and oxyhydroxides.

9. The positive electrode according to claim 1 for a nonaqueous electrolyte secondary battery, wherein the at least one rare earth compound contains at least one rare earth metal selected from erbium, samarium, and neodymium.

10. The positive electrode according to claim 1 for a nonaqueous electrolyte secondary battery, wherein a proportion of the at least one boron compound to a total mass of the lithium transition metal oxide is 0.005% by mass or more and 5% by mass or less on an elemental boron basis.

11. The positive electrode according to claim 1 for a nonaqueous electrolyte secondary battery, wherein the lithium transition metal oxide is in a form of secondary particles formed through association of primary particles.

12. The positive electrode according to claim 11 for a nonaqueous electrolyte secondary battery, wherein particle diameter's of the primary particles of the lithium transition metal oxide are 100 nm or more and 10 μm or less, and particle diameters of the secondary particles of the lithium transition metal oxide are 2 μm or more and 30 μm or less.
